(19) United States
(12) Patent Application Publication
(10) Pub. No.: US 2023/0275770 A1
(43) Pub. Date: Aug. 31, 2023

(54) PSEUDO-RANDOM SELECTION ON THE BLOCKCHAIN

(71) Applicant: nChain Licensing AG, Zug (CH)

(72) Inventors: Jack Owen DAVIES, London (GB); Chloe TARTAN, London (GB)

(21) Appl. No.: 18/017,833

(22) PCT Filed: Jul. 19, 2021
(86) PCT No.: PCT/EP2021/070107

§ 371 Date: Jan. 24, 2023

(30) Foreign Application Priority Data
Aug. 11, 2020 (GB) 2012486.3

(51) Int. Cl. H04L 9/00; G06F 7/58; H04L 9/08

(52) U.S. Cl. CPC H04L 9/50; G06F 7/582; H04L 9/0869

(57) ABSTRACT

A computer-implemented method of pseudo-randomly selecting a data element using blockchain transactions, wherein the method is performed by a first party and comprises: obtaining an ordered list of data elements and a plurality of seed inputs; generating a first transaction; and causing the first transaction to be made available to one or more blockchain nodes for inclusion in the blockchain, wherein the first transaction comprises a first output script, and wherein when executed alongside an input script of a second transaction, the first output script is configured to: output a re-ordered list of the data elements; output a pseudorandom number generated based on the plurality of seed inputs; and output, as a selected data element, the data element positioned at a position in the re-ordered list of data elements corresponding to the pseudorandom number.

### CROSS REFERENCE TO RELATED APPLICATIONS

This application is the U.S. National Stage of International Application No. PCT/EP2021/070107 filed on Jul. 19, 2021, which claims the benefit of United Kingdom Patent Application No. 2012486.3, filed on Aug. 11, 2020, the contents of which are incorporated herein by reference in their entireties.

### TECHNICAL FIELD

The present disclosure relates to a method of pseudo-randomly selecting a data element using blockchain transactions. The selected data element may be used on the blockchain (e.g. as part of a locking condition) or extracted for use off-chain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

### SUMMARY

Pseudorandom numbers are used in many applications, including electronic games, computer simulations, and cryptography. Moreover, pseudorandom numbers can be used to make pseudorandom selections, i.e. a deterministic but unpredictable selection of a data element. Performing such a selection on the blockchain is advantageous because it is verifiable and immutable.

An output script (also known as a locking script) of a blockchain transaction can be configured to pseudo-randomly select a data element from a list of data elements included in that output script (or even a list of data elements included in an input script of a spending transaction). The selection is made based on a pseudorandom number which is either included in the output script or generated during execution of the output script.

However, the inventors of the present invention have realised that the initial ordering of the list of data elements can in some cases bias the selection. This may be undesirable in any of number of possible applications. E.g. if the selected data element is used in the context of a game, this could disincentivise players from participating in the game. Or if the selected data element is used in the context of a computer simulation, the accuracy of the results of the simulation may be negatively affected. As another example, if the selected data element is used in the context of cryptography, the security of the cryptographic system may be compromised.

It would therefore be desirable to eliminate any bias arising from the initial ordering of the list of elements that the pseudorandom number operates on.

According to one aspect disclosed herein, there is provided a computer-implemented method of pseudo-randomly selecting a data element using blockchain transactions, wherein the method is performed by a first party and comprises: obtaining an ordered list of data elements and a plurality of seed inputs; generating a first transaction; and causing the first transaction to be made available to one or more blockchain nodes for inclusion in the blockchain, wherein the first transaction comprises a first output script, and wherein when executed alongside an input script of a second transaction, the first output script is configured to: output a re-ordered list of the data elements; output a pseudorandom number generated based on the plurality of seed inputs; and output, as a selected data element, the data element positioned at a position in the re-ordered list of data elements corresponding to the pseudorandom number.

The first party (e.g. an oracle, trusted third party or a different type of entity) obtains an ordered list of data elements. The first party may generate the ordered list itself (including the order of the elements in the list), or some or all of the elements may be provided by respective users. In that case the order may be based on the respective users, e.g. an index associated with each user or the time at which a respective element is provided, or the first party may again generate the order. The first party also obtains a set of seed inputs that are used to generate the pseudorandom number. Each user may provide a respective seed input, and optionally the first party may also provide a seed input.

The first transaction includes a locking script that is configured to select a data element based on a pseudo-randomly generated number (which may be pre-generated, or generated during script execution). The pseudorandom number corresponds to a position in the list of data elements. In other words, there is a maximum number of the data elements in the list, and the pseudorandom number is an integer between zero (or one, depending on implementation details) and the maximum number.

It can be said that the initial ordering of the data elements affects the selection process. Therefore re-ordering the list before the pseudorandom number is used to select a data element eliminates any bias introduced by the initial ordering. The premise is to mitigate non-uniformities in the distribution of the pseudorandom generator output by incorporating a mechanism to ensure that it is not possible to auspiciously influence the selection by means of a preferential initial ordering.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of an example system for implementing embodiments of the present invention,

FIG. 4 schematically illustrates the execution of an example script for generating a random number,

FIG. 5 illustrates an example initiation transaction,

FIGS. 6 and 7 illustrates example oracle transactions,

FIG. 8 illustrates an example winnings-redemption transaction,

FIG. 9 schematically illustrates the execution of a script for spending funds encumbered by the oracle transaction,

FIG. 10 is a diagrammatic representation of a composite hash function, comprising the two different hash functions H₁, H₂,

FIG. 11 shows the distribution of outputs of f(x) under randomly selected inputs,

FIG. 12 shows the probability distribution of a generic function of the form f(x)=x mod N, with domain {0, 1, . . . , k−1}, and

FIGS. 13 and 14 schematically illustrate example initiation and oracle transactions, respectively, according to some embodiments of the present invention.

### DETAILED DESCRIPTION OF EMBODIMENTS

### Example System Overview

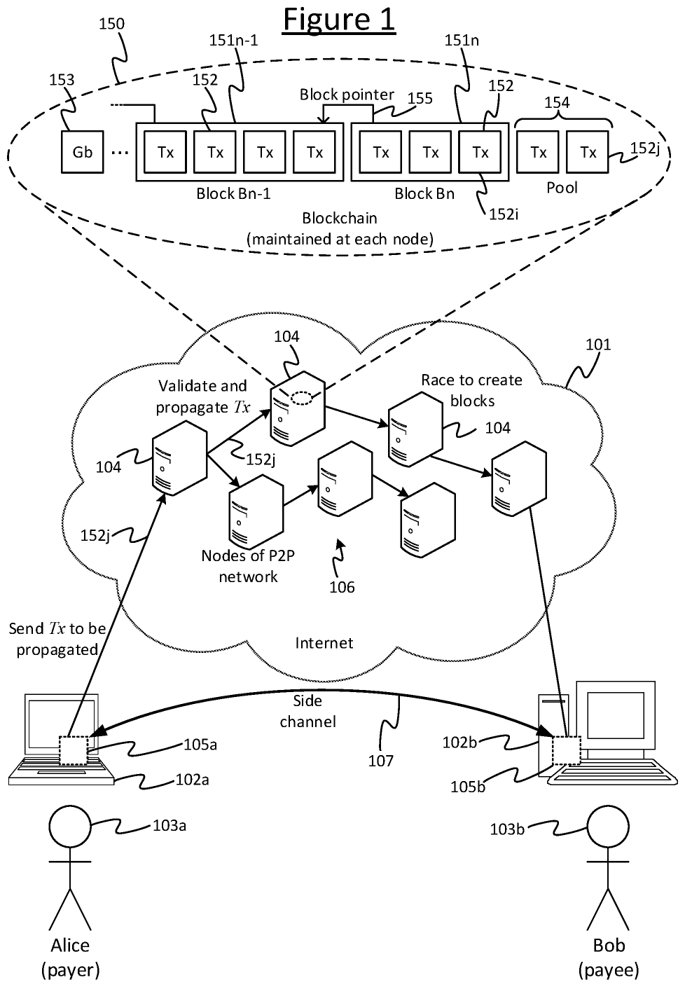

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed a “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

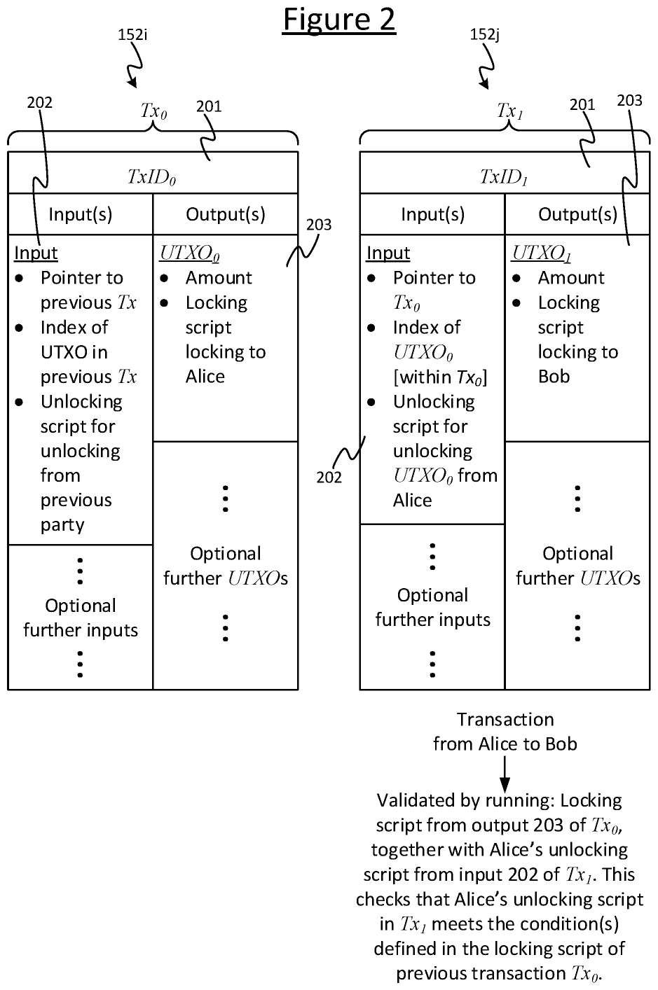

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx1”. It takes an amount of the digital asset that is locked to Alice in the output 203 of a preceding transaction 152i in the sequence, and transfers at least some of this to Bob. The preceding transaction 152i is labelled “Tx0” in FIG. 2. Tx0 and Tx1 are just arbitrary labels. They do not necessarily mean that Tx0 is the first transaction in the blockchain 151, nor that Tx1 is the immediate next transaction in the pool 154. Tx1 could point back to any preceding (i.e. antecedent) transaction that still has an unspent output 203 locked to Alice.

The preceding transaction Tx0 may already have been validated and included in a block 151 of the blockchain 150 at the time when Alice creates her new transaction Tx1, or at least by the time she sends it to the network 106. It may already have been included in one of the blocks 151 at that time, or it may be still waiting in the ordered set 154 in which case it will soon be included in a new block 151. Alternatively Tx0 and Tx1 could be created and sent to the network 106 together, or Tx0 could even be sent after Tx1 if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx0 comprises a particular UTXO, labelled here UTXO0. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO0 in the output 203 of Tx0 comprises a locking script [Checksig PA] which requires a signature Sig PA of Alice in order for UTXO0 to be redeemed (strictly, in order for a subsequent transaction attempting to redeem UTXO0 to be valid). [Checksig PA] contains a representation (i.e. a hash) of the public key PA from a public-private key pair of Alice. The input 202 of Tx1 comprises a pointer pointing back to Tx1 (e.g. by means of its transaction ID, TxID0, which in embodiments is the hash of the whole transaction Tx0). The input 202 of Tx1 comprises an index identifying UTXO0 within Tx0, to identify it amongst any other possible outputs of Tx0. The input 202 of Tx1 further comprises an unlocking script <Sig PA> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx1 arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

### <Sig PA><PA>∥[Checksig PA]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key PA of Alice, as included in the locking script in the output of Tx0, to authenticate that the unlocking script in the input of Tx1 contains the signature of Alice signing the expected portion of data. The expected portion of data itself (the “message”) also needs to be included in order to perform this authentication. In embodiments the signed data comprises the whole of Tx1 (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx1 meets the one or more conditions specified in the locking script of Tx0 (so in the example shown, if Alice's signature is provided in Tx1 and authenticated), then the blockchain node 104 deems Tx1 valid. This means that the blockchain node 104 will add Tx1 to the ordered pool of pending transactions 154. The blockchain node 104 will also forward the transaction Tx1 to one or more other blockchain nodes 104 in the network 106, so that it will be propagated throughout the network 106. Once Tx1 has been validated and included in the blockchain 150, this defines UTXO0 from Tx0 as spent. Note that Tx1 can only be valid if it spends an unspent transaction output 203. If it attempts to spend an output that has already been spent by another transaction 152, then Tx1 will be invalid even if all the other conditions are met. Hence the blockchain node 104 also needs to check whether the referenced UTXO in the preceding transaction Tx0 is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO0 in Tx0 can be split between multiple UTXOs in Tx1. Hence if Alice does not want to give Bob all of the amount defined in UTXO0, she can use the remainder to give herself change in a second output of Tx1, or pay another party.

In practice Alice will also usually need to include a fee for the bitcoin node 104 that successfully includes her transaction 104 in a block 151. If Alice does not include such a fee, Tx0 may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO0 is the only input to Tx1, and Tx1 has only one output UTXO1. If the amount of the digital asset specified in UTXO0 is greater than the amount specified in UTXO1, then the difference may be assigned by the node 104 that wins the proof-of-work race to create the block containing UTXO1. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key PA. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Pseudorandom Selections

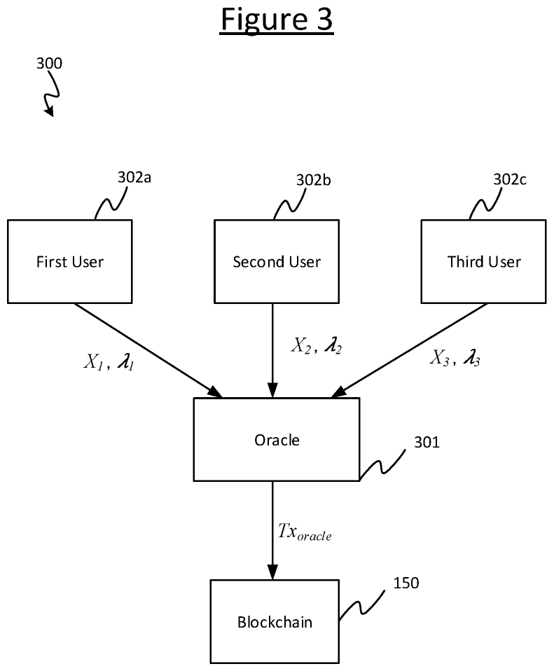

FIG. 3 illustrates an example system 300 for implementing some embodiments of the present invention. As shown, the system 300 includes an oracle 301 and one or more users 302. In this example the system includes three uses 302a, 302b, 302c, but in general the system 300 may include any number of users 302. It is also not excluded that the system 300 does not contain any users 302. That is, some embodiments of the present invention may be performed solely by the oracle 301. Note also that the term “oracle” is used merely as a label for an entity (“first party”) of the system 300, and does not necessary imply that the oracle must be configured to perform any actions other than those described below, whilst that is also not excluded. The system 300 also comprises one or more blockchain nodes 104, represented in FIG. 3 by the blockchain 150 itself.

The oracle 301 and each user 302 operates respective computer equipment (not shown). The respective computer equipment comprises respective processing apparatus comprising one or more processors, e.g. one or more CPUs, GPUs, other accelerator processors, application specific processors, and/or FPGAs. The respective computer equipment further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the respective computer equipment stores software comprising a respective instance of at least one client application arranged to run on the processing apparatus. It will be understood that any action attributed herein to the oracle 301 or a given user 302 may be performed using the software run on the processing apparatus of the respective computer equipment of the oracle or the user. The respective computer equipment comprises at least one user terminal, e.g. a desktop or laptop computer, a tablet, a smartphone, or a wearable device such as a smartwatch. The respective computer equipment may also comprise one or more other networked resources, such as cloud computing resources accessed via the user terminal.

The oracle 301 may be configured to perform any of the operations described as being performed by Alice 103a or Bob 103b as described above with reference to FIGS. 1 and 2. Similarly, any given user 302 may be configured to perform any of the operations described as being performed by Alice 103a or Bob 103b as described above with reference to FIGS. 1 and 2.

In general, the oracle 301 is configured to obtain an ordered list of data elements and a plurality of seed inputs. The seed inputs are used to generate a pseudorandom number, and the pseudorandom number is used to select a data element. The oracle 301 may provide one or more seed inputs, and/or each user 302 may provide a respective seed input. Some or all of the data elements may be provided by the oracle 301. Similarly, some or all of the data elements may be provided by a single user 302, or each user 302 may provide one of the data elements.

The data elements are arranged into an ordered list. The data elements may be placed into the order based on one or more predetermined conditions. For instance, the data elements may be arranged alphabetically (if the data elements are strings), or in increasing or decreasing size order (if the data elements are numbers). Alternatively, the data elements may be placed in an order depending on which user 302 provided the data element. For instance, each user may be associated with an index and the data element provided by a given user 302 is placed in the list at a position corresponding to the index. As another example, the users 302 may provide their data element at different times, and the data elements may be placed in the ordered list one after another.

The oracle 301 generates a first transaction, which will be referred to below as an oracle transaction. The oracle transaction includes an output script, or locking script. The locking script is configured to re-order the ordered list of data elements and select a data element from the re-ordered list of data elements based on a pseudo-randomly generated number. That is, the locking script is configured to operate on the ordered list of data elements to generate the re-ordered list of data elements. The pseudorandom number may be generated during execution of the locking script (as explained below), or the pseudorandom number may have been pre-calculated and included in the locking script.

Re-ordering the list of data elements may comprise one or more successive iterations of changing the order of the data elements in the list. That is, a first iteration may change the position of at least two data elements in the ordered list (that is, at a minimum two data elements change position in the list) to generate an updated ordered list. Then, a second iteration may change the position of at least two data elements in the updated ordered list to generally a newly updated ordered list. This process may be repeated any number of times. For instance, the number of iterations may be equal to the total number of elements in the list. In some examples, at least three elements change position in the list during each iteration. Note that one or more elements may have the same position in the re-ordered list as in the ordered list, depending on the re-ordering operation.

The list of data elements may be re-ordered based on one or more shift inputs. Some or all of the shift inputs may be provided by the users 302. Or, some or all of the shift inputs may be provided by the oracle 302. Starting first with the example of a single shift input (call it, an “overall shift”), the locking script of the oracle transaction may be configured to change the order of the data elements based on the overall shift. The overall shift is included in the locking script, or it may be calculated during execution of the locking script. The locking script may be configured to change the position of one, some or all of the elements in the ordered list, e.g. in one operation or in successive re-ordering iterations. E.g. two or more elements change position based on the overall shift during a first iteration, then two or more elements change position based on the overall shift during a second iteration, and so on. Depending on the value of the overall shift (which is an integer), one or more of the same data elements may change position during successive iterations.

In some examples, the overall shift may be generated by combining (e.g. summing or concatenating) the individual shift inputs, and converting that combined result to an integer less than or equal to the total number of elements in the list. Or, the overall shift may be (randomly) chosen by the oracle 301.

In other examples, the individual shift inputs may be used during successive re-ordering iterations. That is, a first shift input is used during a first iteration, a second shift input is used during a second iteration, and so on. In this case, the number of shift inputs matches the total number of elements in the list.

As discussed above, the pseudorandom number is generated based on a plurality of seed inputs, some or all of which may be provided by the users 302 (one per user 302). The pseudorandom number is generated by applying a function to the plurality of seed inputs. For instance, the function may combine the plurality of seed inputs, e.g. by summation or concatenation. The function may also apply a composite hash function to the result of the combination. An example of a composite hash function is a cryptographic hash function followed by a modulo function. In other words, the combination of the seed inputs is first input to a cryptographic hash function (e.g. SHA-256), and then the resulting hash digest is input to a modulo function in order to generate a number less than or equal to the total number of elements in the list. In general the seed inputs may take any form. For instance, the seed inputs may be arbitrary data items, or the seed inputs may be components of a signature generated by a respective user (discussed in detail below). The locking script may generate the pseudorandom number during script execution, in which case the locking script includes the plurality of seed inputs.

If one or more of the shift inputs are obtained from respective users 302 (i.e. one per user 302), the shift inputs may be arranged in an ordered list, wherein the order is based on the users 302, e.g. a respective index of the user. For instance, the shift input sent to the oracle 301 by the first user 302a may be placed first in the list, the shift input sent to the oracle 301 by the second user 302b may be placed second in the list, and so on. Additionally or alternatively, the order of the shift inputs may be determined based on the order of the data elements and/or the seed inputs. For instance, each user may provide a respective data element (e.g. a public key) and/or a respective seed input, with those data elements and/or seed inputs being arranged into respective ordered lists. If a user's data element and/or seed input is placed first in the respective ordered lists, then the same user's shift input may be placed first in the ordered list of shift inputs.

The selected data element may be used by a spending transaction, i.e. a transaction containing an input that references the output of the oracle transaction. For instance, the selected data element may be used as part of a locking condition that must be satisfied by the input script, or unlocking script, of the spending transaction. As a particular example, the data elements may be public keys, and the locking script of the oracle transaction may require the unlocking script of the spending transaction to include a signature corresponding to the selected public key.

Additionally or alternatively, the selected data element may be used off-chain, i.e. not in a blockchain context. For instance, the selected data element may be supplied to an off-chain function, e.g. as an input to a computer simulation.

As explained above with reference to FIG. 2, during execution of the locking script, data is output to a stack. The stack is a form of memory. During execution of the locking script of the oracle transaction, the re-ordered list of elements, the pseudorandom number, and the selected data element may be output to the stack. Similarly, the initial ordered list of elements may be output to the stack. An example execution flow of the locking script is provided further below.

The oracle transaction includes one or more inputs. In some examples, the oracle transaction may include an input that references an output of an initiation transaction. Each user 302 includes in the initiation transaction a respective shift commitment of their respective shift input. For instance, the shift commitment may be a hash of the respective shift input. The shift commitment may take other forms, e.g. the shift input may be obfuscated with an elliptic curve generator point. The initiation transaction may also include a seed commitment to the user's seed input. Again, this seed commitment may be a hash of the respective seed input. In other examples, the seed input may be a first component of a digital signature (e.g. an ECDSA signature) and the seed commitment may be a second component of the same signature. As a particular example, each user 302 may generate a respective signature of the form [r, s], with s being the seed input and r being the seed commitment. In some examples, each user may provide a single commitment which commits to both the shift input and the seed input. For instance, the shift input and seed input may be concatenated and then hashed to form the single commitment.

The shift and/or seed commitments may be included in respective unspendable outputs of the initiation transaction, e.g. OP_FALSE OP_RETURN outputs. It is also not excluded that the commitment(s) may be included in respective spendable outputs. Depending on the use case, each user 302 may contribute their commitment(s) separately to the initiation transaction (e.g. by signing respective inputs of the initiation transaction), or a single user 302a may add each user's commitment(s) to the initiation transaction.

Instead of referencing a single initiation transaction, the oracle transaction may reference multiple initiation transactions, with each user 302 generating a respective initiation transaction. Similar to the single initiation transaction, each individual initiation transaction generated by a user 302 may include a commitment of the shift input and/or seed input provided by that user 302.

The following provides further details on the generation of pseudorandom numbers on the blockchain 150. Some or all of the following features may be implemented by the oracle 301 or users 302 of the system 300. Note that the following section is provided for illustrative purposes only and intended as being limiting on all embodiments of the present invention. For instance, the present invention is not limited only to the bitcoin blockchain, nor to the context of gaming applications.

### Example Blockchain-Based PRNG

The conception of a new method for incorporating random processes into the blockchain 150 was motivated in large part by the need to allow gaming algorithms based on luck into the Bitcoin script. This means that the method must ensure the following properties of the random numbers that are to be generated and used in script:
(1) Unpredictable: the random number to be used in determining outcomes should not be predictable before funds are committed to a luck-based event.
(2) Deterministic: the random number(s) generated should be reproducible from the same inputs at all times after the initial generation.
(3) Verifiable: all parties (e.g. users 302) should be able to reproduce and verify the chosen random number such that all parties agree on the number(s) that has been generated.

The following method ensures all the above properties are upheld in the generation of random numbers on the blockchain 150.

### Pseudo-Random Number Generators

In general, random numbers fall into two categories; truly-random and pseudo-random. The distinction to be made is that true-randomness is very hard to achieve and is usually reliant on natural processes or electrical noise.

Alternatively, pseudo-randomness is achieved by using a single high-entropy seed value V_{Seed} (truly-random) to initialise an algorithm for generating a sequence of pseudo-random numbers Nₖ, where k is the period of the random number generator V_{Seed}→(N₁, N₂, . . . , Nₖ).

For most practical applications pseudo-random number generators are used if their properties are suitable. In the case of randomness incorporated on the blockchain 150, the mechanism for pseudorandom number generation should preferably be cryptographically secure.

In general, cryptographically-secure pseudo-random number generators (CSPRNGs) are deterministic and hence produce a sequence of numbers verifiable by anybody who knows V_{Seed}. Such a generator would be suitable for the present purpose, but for two core issues. Firstly, it would be necessary to incorporate a lengthy algorithm from a known CSPRNG into scripting language, which would add computational overhead and limit the opportunity for functions of the random numbers generated by the algorithm.

In addition, there would still exist the problem of being able to provide a seed value V_{Seed} that has entropy sufficient to be classed as truly-random. Currently, there exists neither a mechanism for producing such a seed in-script, nor to use an external seed as input to a redeem script in a way that fulfils the requirement (1) that the generated random number is unpredictable. The present invention proposes to use hash functions as an alternative to generate random numbers.

### Hash Functions

The construction of a blockchain 150 is contingent on the use of hash functions, and their inherent properties. Here a hash function H is defined as a one-way deterministic function that takes an arbitrary data structure X and outputs a 256-bit number H(X)ϵ [symbol] ₂₅₆ Y=H(X), X [symbol] H(X).

The fact that hash functions, such as SHA-256, behave as one-way random oracles should be appreciated here. That is to say if a hash Y is computed from a pre-image X that is not known to a user, it is computationally difficult for the user to find X.

A property of hash functions is that the hashes of two 256-bit data structures, which differ in the value of a single bit only, can be treated as completely unrelated. In other words, a hash value behaves as a true random number with respect to the user, so long as that user does not know the pre-image in its entirety.

This means that we may simply take a hash value Y—or some function of it—and treat it as the single random number R we seek to produce, under the assumption that no single party has control over the entire input pre-image X

R:=Rand:=Y=H(X); for unknown X.

By extension, one may generate a random number sequence S_{R}, of (k+1)—random values, by repeated hashing of an initial random number R₀ using the same arguments

R₀=H(X₀); R₁=H(R₀); Rₖ=H(Rₖ₋₁),
S_{R}=(R₀, R₁, . . . , Rₖ).

Since hash functions are deterministic, any party may reproduce the entire sequence S_{R} with knowledge only of the specific hash function used and the initial pre-image X₀, which hereby acts as a seed.

If this initial pre-image is made public at the time when the random sequence is generated, any party may independently verify that the sequence corresponds to this pre-image. It is clear then that hash functions may be used to generate random-number sequences to be used in-script that satisfy of our criteria (1) and (2), provided only that no single party involved in generating the random number(s) can manipulate the entire initial pre-image X₀.

### Alternative One-Way Functions

In general, the term ‘hash function’ may be used herein to refer to a specific type of a one-way function, which a broader class of functions, because hash functions have existing opcodes in the blockchain scripting language. However, it is conceivable that alternative one-way functions can be used in place of any instance of a hash function herein. Two examples include:
1. Elliptic Curve (EC) point multiplication—the function E(x)=x·G that is used to generate an EC public key from a private key, where G is the elliptic curve base point and ‘·’ is the EC point multiplication operator. This is a one-way function as it is easy to compute E(x) given x, G but computationally difficult to determine x given E(x), G.
2. The Rabin function—the function R(x)=x² mod N, where N=pq for p, q both prime. It is easy to find the square R(x) modulo N, while finding square roots ±x given R(x), N is as difficult as factoring N to find p, q, which is computationally hard.

### Digital Signatures

The following provides a summary of both how digital signatures are formed and what their basic structure comprises under the ECDSA standard. Note that any reference to a digital signature used herein is not necessarily limited to ECDSA signatures.

Consider a user, Alice, who wishes to create a digital signature for a message hash H(m) using her private key S_{A}. Alice has a public key P_{A} associated with her private key in the usual way according to ECC, where G is the elliptic curve base point of order n

P_{A}=S_{A}·G.

There are two components of the digital signature that need to be created: r and s. Alice generates an ephemeral key as a random number kϵ [symbol] *ₘ and uses this to derive part r of the signature as

(Rₓ,R_{y})=k·G,
r=Rₓ.

The part s of the signature is then derived from this in combination with Alice's private key, her hashed message and the ephemeral key as

s=k⁻¹(H(m)+S_{A}*r)mod n.

By concatenating r and s a data structure known as the ECDSA digital signature of the message hash is created

### Sig P_{A}=(r, s).

Given separately the values r and s, the full signature may be constructed in the blockchain scripting language using the operator OP_CAT. When the signature is reconstructed it must be of the standard DER format to be used in script. This point becomes important when using the signature method described below for generating random numbers.

### Method

There are three variations of the general method for generating a random number (i.e. the pseudorandom number used in the oracle transaction generated by the oracle 301) using the blockchain 150. Each method involves multiple users 302 who join to create the random number.

The first method uses a combination of hash pre-images to produce a secure random number, while the second uses a combination of the s-components from several signatures. Finally, a third method is a hybrid of the first two methods. In each case, the aim is to produce a secure random integer R_{N}ϵ{0,N−1}.

### The Hash Method

Consider N users 302 each of whom make public their own hash value Yᵢ=H(Xᵢ), where we stipulate that each user 302 chooses their own secret pre-image Xᵢ. The properties of hash functions allow one to assume that no user 302 can guess another's pre-image given knowledge of the public hash value.

The users 302 then send their secret pre-image Xᵢ to an oracle 301. The pre-images may be sent via a secret value distribution technique, e.g. as described in WO2017145016A1, but other secure channels or mechanism for communicating the pre-image to the oracle 301 may be used. The oracle 301 then produces a random number R_{N} via the following method.
1. The oracle verifies that Yᵢ=H(Xᵢ) for the pre-image provided by each user 302.

Here, the pre-image Xᵢ is equivalent to the seed input described above, and Yᵢ is equivalent to the seed commitment.

Recall that the hash values have already been made public prior to the pre-images being sent to the oracle 301. This ensures that the oracle 301 is fed the correct pre-images as supplied originally by each user 302. On the blockchain 150 these public values are immutable, and thus cannot be changed by a user 302 after sending the pre-image.

This verification step ensures that the oracle 301 will not proceed in generating a random number until all users have supplied it with their chosen secret pre-image.
2. The oracle computes R_{N} as

$${R}_{N} = H ( {\sum }_{i} {X}_{i} ) mod N$$

R_{N} is a random number with respect to each and every user 302 provided only that no user 302 knows all N of the original pre-image values Xᵢ.

All the pre-images are kept secret by the users 302 and are communicated securely to the oracle 301. This means that there is no way a malicious party may know all these inputs unless they control all users 302 involved. In this case the adversary would trivially be manipulating a random number to be used by itself only.

In all other scenarios, where there is a minimum of one genuine user 302, the described properties of hash functions mean that they cannot manipulate R_{N} in an advantageous way. This is true even when the adversary controls all N−1 other users.

Put simply, there is no way for any party to influence the random number generated by this method that can adversely affect another party. Note that here an additive ‘+’ summation of the preimages Xᵢ is used as this is simple to implement in script, but it is possible to use a different operator, such as concatenation, in series analogous to the summation above.

The concatenation version of the ΣXᵢ ‘summation’ is advantageous because it is secure against second preimage attacks. That is, if the input to the hash is x₁+x₂+x₃+ . . . then it is trivial to find different combinations of xᵢ that give the same results, because order doesn't matter. Whereas in the concatenation scenario, order does matter and it is not possible to find different sets of values xᵢ that give the same concatenation, in order.

The random number R_{N} has been generated in a way that is both (1) unpredictable to any party involved in the process and (2) reproducible via a deterministic process. The final requirement of those set out above, that the random number is (3) verifiable, will be shown to be met below.

As discussed, an extension is that a random number sequence may also be generated by the oracle by repeated hashing of R_{N}.

### The Signature Method

Now consider N users each of whom make public a signature Sig Pᵢ as well as a random value r′₁ that forms part of a second signature Sig P′ᵢ whose s′-component is kept secret.

Sig Pᵢ=(rᵢ,sᵢ),
Sig P′ᵢ=(r′ᵢ,s′ᵢ).

The signatures should be signed using the same private key Sᵢ such that it can be verified that both signatures correspond to the same owner of a public key Pᵢ,

Pᵢ=Sᵢ·G.

The users 302 then send their secret s′ᵢ values (i.e. the seed inputs) to an oracle 301, e.g. via a secret-sharing method or otherwise securely. The oracle 301 then produces a random number R_{N} via the following method.
1. The oracle constructs Sig P′ᵢ and verifies that it corresponds to the same entity as Sig Pᵢ for each user 302.

This second signature is constructed by concatenating the public r′ᵢ value (i.e. the seed commitment) with the secret 4 value (i.e. the seed input).

The oracle applies the standard ECDSA signature verification algorithm to both signatures and confirms that they were commonly signed by the owner of the public key Pᵢ. This ensures that another user 302 cannot influence the random number by providing their own signature for a given r′ᵢ value.
2. The oracle computes R_{N} as

$${R}_{N} = H ( {\sum }_{i} {s}_{i}^{′} ) mod N$$

This inherits the same properties outlined in the hash method due to the analogy of one-way hash functions with the one-way process of generating a public key from a private key in ECC. By replacing Yᵢ→Pᵢ and Xᵢ→s′ᵢ the analogy is clear, and the arguments presented in step 2 of the hash method hold here. Strictly speaking for direct analogy one would replace Xᵢ→Sᵢ, but s′ᵢ is simply a function of Sᵢ.

The random number R_{N} is generated, as with the hash method, in a way that is both unpredictable to any party involved and verifiable, satisfying criteria (1) and (2) outlined above.

It should be made clear that the signature method and the hash method are directly analogous to one another and share core properties of their respective methods for random number generation. In particular, both methods require each user to be responsible for generating a secret value; Xᵢ and s′ᵢ for the hash and signature methods respectively. A key advantage of using the signature method here is that the act of choosing the secret is already standardised under the ECDSA procedure, while choosing an arbitrary hash pre-image is not.

The signature method also provides a way to directly verify the secret value s′ᵢ sent to the oracle 301 has been provided by the original proposer of the corresponding public value r′ᵢ by comparison with the primary signature Sig Pᵢ=(rᵢ, sᵢ) that accompanied it. This verification is only an implicit one in the hash method.

Calculating R_{N} in-Script

In both regimes the random number R_{N} has been shown to fulfil the requirements of being both (1) unpredictable and (2) deterministic. The following shows how it is also (3) verifiable.

This means that there needs to be a way for all network peers to independently verify that R_{N} has been generated in the correct way. This is achieved by demanding that R_{N} itself be calculated and used in the locking script of a transaction.

In this way all the previously-secret s′ᵢ values are published on the blockchain as part of this script, meaning that anybody can verify the random number by constructing the input pre-image of a hash function Σᵢs′ᵢ.

An examples script of the following form may be used for generating the desired random integer R_{N}ϵ{0,N−1}

<R_{N}>=<s′₁><s′₂> . . . <s′_{N}>OP_ADD OP_ADD OP_HASH256<N>OP_MOD,
where there are N−1 uses of the operator ‘OP_ADD’ and N secret values.

In the applications presented below, <R_{N}> will be used to refer to this script. Note that this script can be used for generalised secret values including hash pre-images, partial signatures and combinations of these.

FIG. 4 shows how this script is used to generate a random number.

The full locking script for a transaction (i.e. the oracle transaction) can include the verification that each pre-image corresponds to the correct committed hash, that each secret signature component combines with the public component to form the expected signature and that each supplied value has come from the correct user 302.

### Preimage Verification

The following script can be used to verify that each of the supplied preimages Xᵢ correspond to the correct pre-committed hash values Yᵢ as an in-script process.

<Verify1>=<Y₁><X₁>OP_SHA256OP_EQUAL . . . <Y_{N}><X_{N}>OP_SHA256OP_EQUAL

### Signature Verification

The following script can be used to verify that each of the supplied secondary signatures Sig P′ᵢ and the initial signatures Sig Pᵢ both correspond to the public key Pᵢ, again as an in-script process.

<Verify2>=<P₁>OP_DUP<Sig P₁>OP_SWAP<m>[Verify ECDSA]<s′₁><r′₁>OP_CAT OP_SWAP<m>[Verify ECDSA] . . . <P_{N}>OP_DUP<Sig P_{N}>OP_SWAP<m>[Verify ECDSA]<s′_{N}><r′_{N}>OP_CAT OP_SWAP<m>[Verify ECDSA]
where [Verify ECDSA] is a sub-script configured to implement ECDSA signature verification in-script, and verifies the signature against any message <m> that is provided as a parameter.

### A Combined Method

The methods presented so far are robust to malicious parties attempting to influence the outcome of the random number produced. However, there are many ways in which the hash method and signature method may be extended and combined in order to improve the security and unpredictability of the random number(s) generated.

The simplest combination of the two methods would be for each user to publish a hash value Yᵢ as well as a signature Sig Pᵢ, random value r′ᵢ and their public key Pᵢ. The oracle may then produce a random value as

$${R}_{N} = H ( {\sum }_{i} {X}_{i} + {s}_{i}^{′} ) mod N$$

where each user 302 has also privately computed a secondary signature Sig P′ᵢ=(r′ᵢ,s′ᵢ). Note that the addition operator ‘+’ here could be replaced in another implementation by another operator, such as concatenation or an XOR.

Either of the two methods may also be extended individually by imposing that multiple oracles are invoked and users 302 each provide multiple seed inputs, e.g. multiple hash values Yᵢ or multiple secondary r′ᵢ values.

For instance, if two oracles were invoked using the hash method, the random number R_{N} may be calculated as

$${R}_{N} = H ( {\sum }_{i} {X}_{i , 1} + {\sum }_{i} {X}_{i , 2} ) mod N$$

where the first oracle sends the sum of one set of pre-images X_{i,1} to the second, who adds this to the sum of a second set of pre-images X_{i,2} and computes the random number.

By invoking a number of oracles, the risk of an oracle being somehow corrupted by a malicious user is eliminated. Extending this to a large number of oracles reduces the risk of all oracles colluding, at the expense of greater computational and temporal overheads. Note that these methods ensure that only a single oracle needs to be genuine for the random number to be generated securely and unpredictably.

### Example Applications

The following sets out some example use-cases for the present invention.

The first application is in the context of a blockchain lottery involving N users 302, considered both in scenarios with and without a party (i.e. oracle) who acts as a ‘house’. The second application is for an N-sided game of Satoshi dice, whereby a user 302 participates in a simple game of luck with a house (oracle 301).

Finally, more general uses for generating random numbers using the blockchain 150 are considered.

### Lotteries

Consider a group of N users 302 with associated public keys Pᵢ, ∀iϵ{1, N}. We will construct a lottery involving these users 302, where the winning funds will be locked to the owner of the randomly selected public key P_{W}.

The structure of the lottery comprises three transactions
(i) An initiation transaction
(ii) An oracle transaction
(iii) A winnings-redemption transaction
   and will invoke one oracle 301 for the secure generation of a random number that is used to lock the winning funds to P_{W}.

In such a lottery, we ensure that each user 302 has an equal chance of winning N×x with probability 1/N, where x is the initial buy-in value for a lottery ticket.

We will also consider separately the case where we include a ‘house’ as part of the lottery, who may recoup the lottery funds if the winning party does not claim their prize.

In this case, each user 302 has a chance of winning r+(N×x) with probability 1/(N+1), where r is the buy-in contribution of the house.

### Initiation Transaction

1. Each user contributes a common value of x to an initiation transaction as their buy-in for a blockchain lottery ticket. This transaction will comprise N inputs and 1 output and represents the digital point of sale of the blockchain lottery ticket for all participants.
2. In addition to the buy-in, each user also includes as input a public value, residing in an output (e.g. an OP_RETURN output). This value will depend on the random number-generation method to be used.

For this implementation, we will use the signature method and thus the value supplied is a random value r′ᵢ, which forms a signature Sig P′ᵢ=(r′ᵢ, s′iᵢ) whose s′iᵢ—component is kept secret.
3. Finally, each user 302 provides their public key Pᵢ and a signature Sig Pᵢ=(rᵢ, sᵢ) corresponding to it. This is done for all users until the transaction contains sufficient inputs to produce a single N×x output. This output is paid to the public key corresponding to the oracle P_{O}.

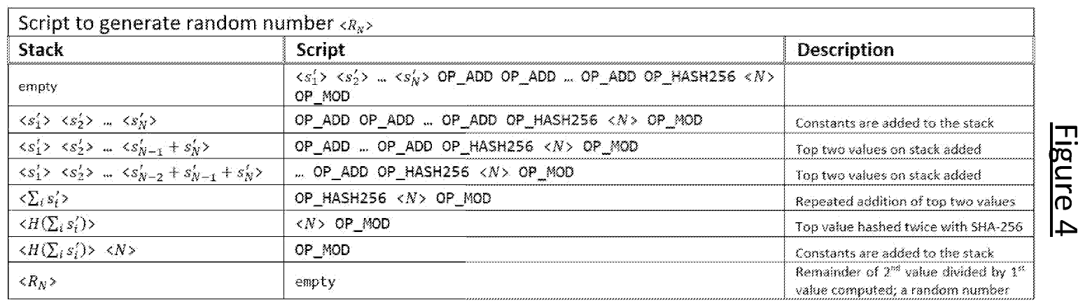

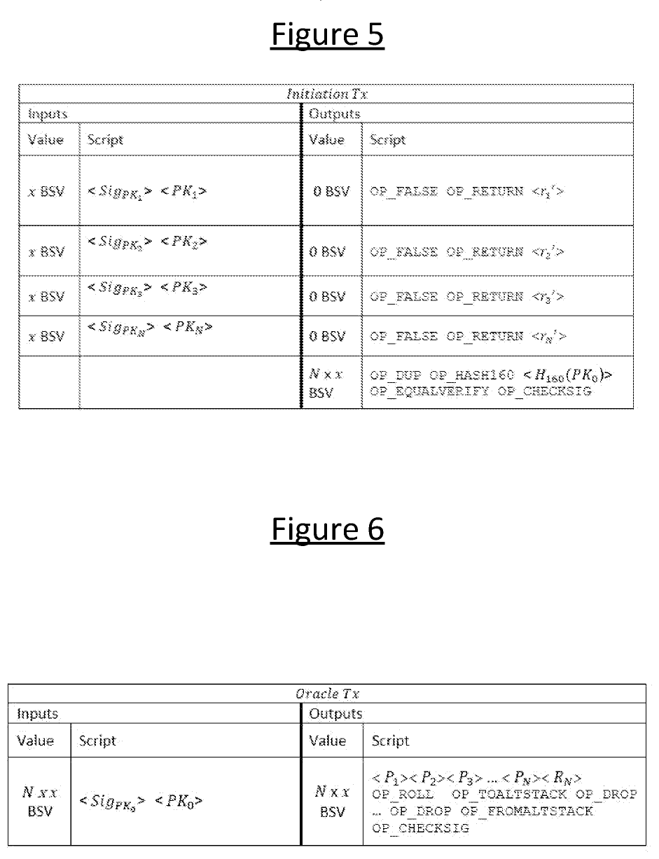

The structure of the initiation transaction is shown in FIG. 5.

### Oracle Transaction

1. Each user sends their secret s′ᵢ to the oracle.

The oracle 301 will be decided upon before even the initiation transaction occurred. It may be a trusted third party, a purpose-built TEE or some other form of oracle.
2. The oracle 301 checks that each secondary signature Sig P′ᵢ=(r′ᵢ, s′ᵢ) and each primary signature Sig Pᵢ=(rᵢ, sᵢ) correspond to the same key-pair associated with public key Pᵢ.
3. The oracle 301 constructs an oracle transaction. This transaction uses the UTXO of the initiation transaction as its only input and locks the entire N×x funds to a single winning public key.

The winning key P_{W} is selected at random using the random number R_{N} that is generated within the locking script of this oracle transaction.

The following script, denoted by <P_{W}>, is used to randomly select the winning public key from the set of N participating keys Pᵢ. It is seeded by our earlier script <R_{N}>, which calculates in-situ the random number that picks the winning key

<P_{W}>=<P₁><P₂> . . . <P_{N}><R_{N}>OP_ROLL OP_TOALTSTACK OP_DROP . . . OP_DROP OP_FROMALTSTACK,
where there are N−1 uses of the operator ‘OP_DROP’ and N public keys.

The structure of an example oracle transaction is shown in FIG. 6.

In the first two lines of the locking script the set of participating public keys are manipulated according to the value produced by the sub-script <R_{N}>. The script then simply requires the signature Sig P_{W}.

The locking script of the oracle transaction encumbers the winning funds to be signed for by the owner of the winning public key P_{W}.

Note that the order in which the public keys appear in this locking script is consistent with the order in which they appear in the initiation transaction, otherwise the oracle can manipulate the outcome by reordering the public keys.

Lottery with a House

In this application we have constructed an N-user lottery in which there is no party who acts as a ‘house’. It may be desirable to extend this concept to such a lottery to ensure that funds are not simply lost and wasted.

For instance, if one party wishes to construct a lottery and offers act as the house by taking on the overheads involved, such as setting up a user-interface, instantiating an oracle or sourcing participants they may wish to be incentivised for doing so.

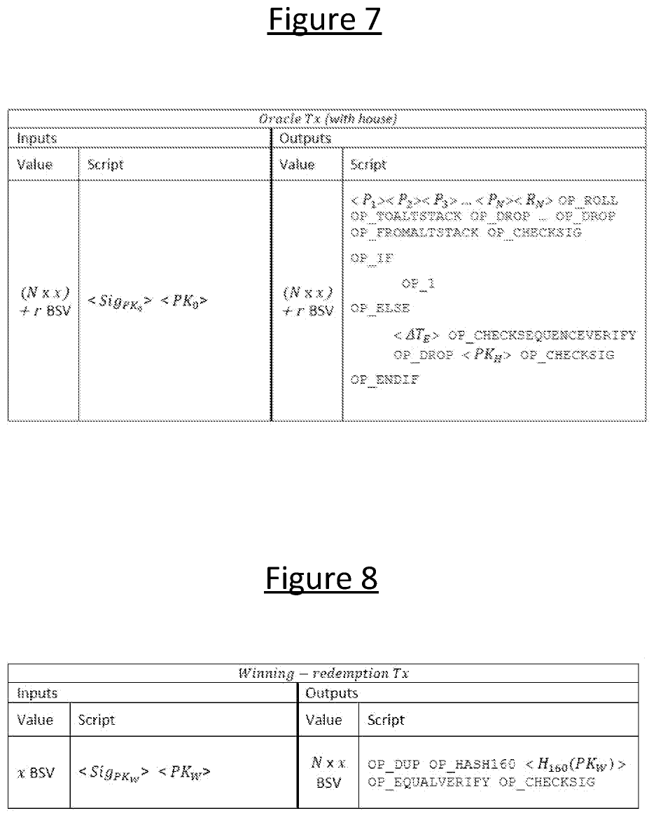

This incentive could be in the form of a timeout mechanism, which would send the winning funds of the lottery to the house. Implementing this lottery would involve N-users contributing x and a house contributing r (see FIG. 7).

The house would be able to recoup the entire lottery funds and pay to their public key PH after some agreed timeout period ΔT_{E} has elapsed if the oracle transaction were modified to take the following form

In the oracle transaction of FIG. 7, the locking script has been modified to include the timeout failsafe, which will allow the party acting as the house to spend the lottery funds if the winning party does not claim their prize before the agreed time.

In this type of blockchain lottery that includes a house, each user has a chance of winning r+(N×x) with probability 1/(N+1), where r is the buy-in contribution of the house. This concept of adding a house to a lottery can be extended to a lottery where there is not necessarily a winner, such as The National Lottery, by including a set of public keys that correspond to the house. In the case that one of these keys is selected the lottery rolls over.

### Winnings-Redemption

Once the oracle transaction is recorded on the blockchain 150 the owner of the winning public key P_{W} may spend the winning funds. A valid transaction of this type is shown in FIG. 8. The unlocking script of this transaction comprises the signature Sig P_{W} corresponding to the winning public key.

When unlocking the funds encumbered by the oracle transaction, this input to the redemption transaction (scriptSig) will be run alongside the locking script (scriptPubKey) of the previous oracle-constructed transaction.

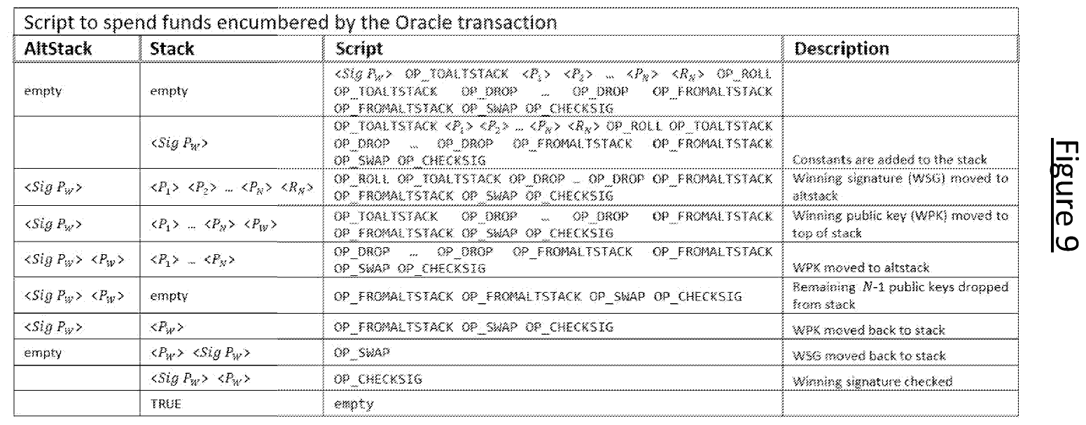

The combination of these two pieces of script is shown in FIG. 9, demonstrating that the winning user can spend the N×x winning funds simply by providing the signature corresponding to the winning public key P_{W}.

### Seeding Other Generators

The above examples have shown how random numbers can be generated in-script and securely using the blockchain protocol.

In the lottery applications presented, we have proposed to use these random numbers for a function immediately in a transaction rather than to use them elsewhere, i.e. for some off-chain purpose.

Embodiments of the present invention enable the generation of a random number through a secure, consensus-based and transparent protocol. For instance, if a single party or an organisation wish to produce a random number to seed an off-chain process they may use the present invention to do so. The party would simply proceed by constructing a transaction flow similar to the one used for the lottery application but without associating significant funds to the global inputs and outputs of the process.

In this way the party may use the blockchain 150 to produce a random number R_{N} or sequence S_{R} in such a way that the mechanism, seed and result are all transparently recorded on the blockchain 150.

### Non-Preferential Ordering

The blockchain-based PRNG method outlined above takes N inputs X₁, X₂, . . . , X_{N}, chosen independently by N users 302, to generate a sequence of pseudo-random numbers. The random number R_{N} that seeds the sequence is generated from the hash of a composite seed, which is derived from the combination all the user seed inputs (and optionally an oracle seed X₀) as, for example

$${R}_{N} = H ( {\sum }_{i} {X}_{i} ) mod N$$

Where H is a cryptographic hash function. This method of determining R_{N} actually employs a composite hash function; a hash function composed of multiple hash functions, where the cryptographic hash function g(x)=H(x) produces output strings of, for example, 256-bits in length, while the function f(x)=x mod N produces outputs in the space of numbers in the range [0, N−1]. The composite hash function that defines R_{N} can now be written using the familiar mathematical notation R_{N}=(f∘g)(x)=f(g(x)).

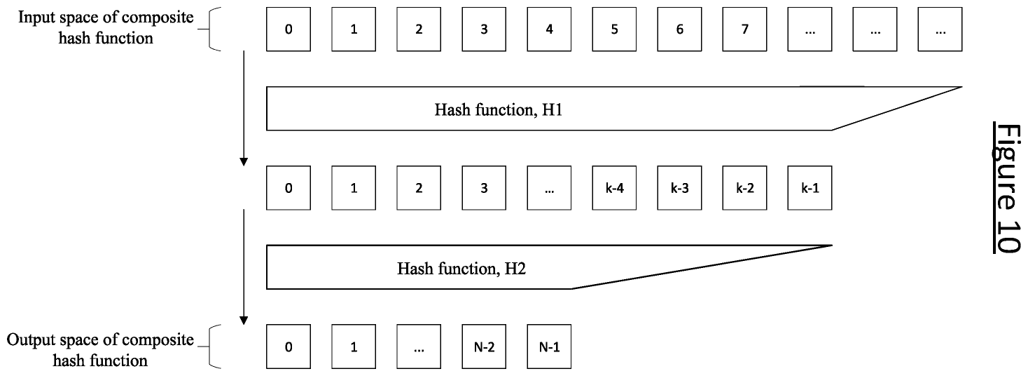

FIG. 10 illustrates a diagrammatic representation of a composite hash function, comprising the two different hash functions H₁, H₂.

The generated random number is used to operate on a list of data elements (e.g. represented by public keys in a blockchain transaction). The data elements may correspond to players and/or symbols in a game. In the first instance, the output from the algorithm can be used to simply pick the R_{N}^{th} player from a list of player keys. A more advanced implementation involves shuffling through a list of game symbols several times using a sequence of generated pseudo-random numbers.

The initial ordering of the list of elements depends on the game and is set by either:
1. the chronological order in which each player joins the game, or
2. the dealer e.g., only the dealer of a card game knows the initial ordering of cards in a deck.

In applications of the above PRNG method, the pseudo-random seed R_{N} is used to operate on an ordered set of elements, whose order is fixed. The necessity for the order of the elements, in this case the players' public keys, to be fixed can present a problem when a winning element is to be chosen using the composite hash function R_{N}=f(x)) detailed previously. If the outputs of the composite hash function are not uniformly distributed, then this will create a bias of outcomes towards a particular position(s) in the list of elements. Given that players may know this bias ahead of time, this would create a scenario in which players may only be willing to participate if they are certain the element(s) in the list that would correspond to them winning will be located in the biased position(s).

Outside of a game context, the bias of a selected data element may negatively impact e.g. computer simulations that rely on the random selection from a set of data.

In the case of the composite hash function, g(x) is a cryptographic hash function, e.g. SHA-256, which is widely known to be uniformly distributed. However, f(x)=x mod N cannot be considered uniformly distributed for all choices of the parameter N and for all domains of x, and there are known conditions that must be met for this to be the case.

Consider a function of the form f(x)=x mod N, with domain {0, 1, . . . , k−1} and whose range is necessarily given by {0, 1, . . . , N−1}.

For the choice of parameters N=10, k=16, we have the function f(x)=x mod 10 with the domain {0, 1, . . . , 15} and range {0, 1, . . . , 9}. The probability of the output f(x)=0, given a random input, is given by

$$P ( f ( x ) = 0 ) = P ( x = 0 ) + P ( x = 10 ) = \frac{1}{16} + \frac{1}{16} = \frac{2}{16}$$

It can be shown similarly that the probability of the outputs f(x)=0,1,2,3,4,5 are all equal to

$$\frac{2}{16} .$$

The probability of the outputs f(x)=6, given a random input, is given by

$$P ( f ( x ) = 6 ) = P ( x = 6 ) = \frac{1}{16}$$

and it can be further shown that the probability of the outputs f(x)=6,7,8,9 are all equal to

$$\frac{1}{16} .$$

| Output value | Probability |
|---|---|
| f(x) = 0 | 2/16 |
| f(x) = 1 | 2/16 |
| f(x) = 2 | 2/16 |
| f(x) = 3 | 2/16 |
| f(x) = 4 | 2/16 |
| f(x) = 5 | 2/16 |
| f(x) = 6 | 1/16 |
| f(x) = 7 | 1/16 |
| f(x) = 8 | 1/16 |
| f(x) = 9 | 1/16 |

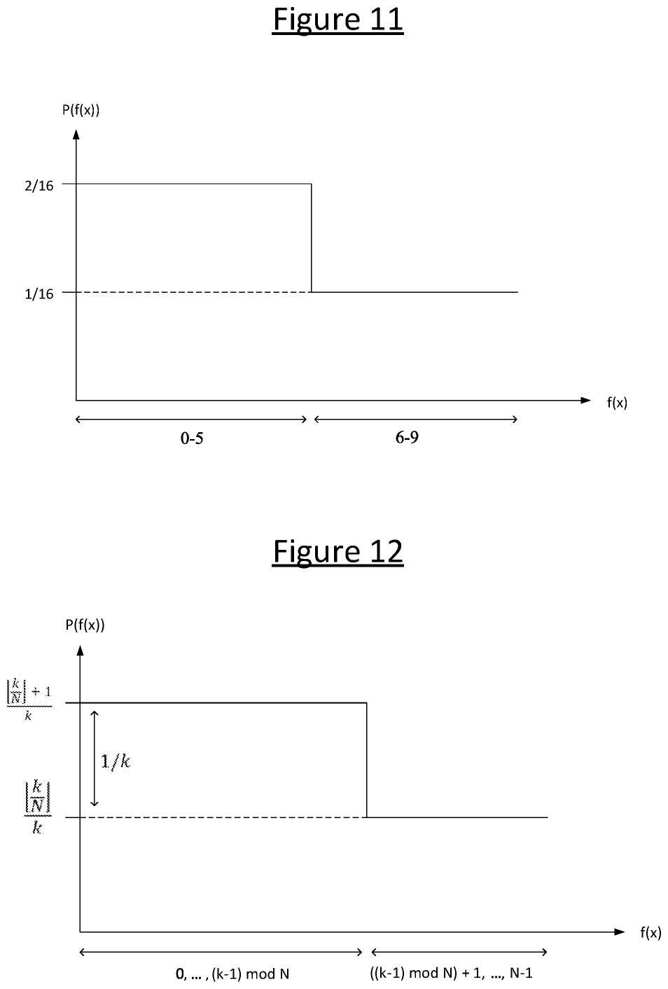

The table above lists the probabilities of each output of f(x) when evaluated at a random input in its domain. We can see that the distribution of the outputs of the function are indeed non-uniform overall, but interestingly the range of f follows a distribution comprising two uniform distributions within the sub-ranges {0, 1, . . . , 5} and {6,7,8,9} respectively, with a step change between them. This distribution is visualised in FIG. 11.

This example function of the form f(x)=x mod N demonstrates an important result that applies generally to functions of this form; that the distribution of outputs is given by a step function where the step change occurs at (k−1) mod N. In the example above, we can see that 15 mod 10≡5 is where the step change does indeed occur.

We can use this general result to inspect the probability distribution for a generic function of the form f(x)=x mod N, with a domain of {0, 1, . . . , k−1}.

The probability of a given output σ≤(k−1) mod N, when f(x) is evaluated at a random choice of input, is given by:

$${P}_{α} ( f ( x ) = σ ) = \frac{⌊ \frac{k}{N} ⌋ + 1}{k}$$

Similarly, the probability of a given output σ>(k−1) mod N, when f(x) is evaluated at a random choice of input, is given by:

$${P}_{β} ( f ( x ) = σ ) = \frac{⌊ \frac{k}{N} ⌋}{k}$$

These values define the two levels in the probability distribution of the outputs of f(x), as shown in FIG. 12. It is notable that the maximum difference in probability between any two outputs if simply defined by the size k of the output space and given by 1/k.

The general results and distribution above apply to the type of composite hash function used in the example PRNG method described above, which we recall takes the composite form f(x)=H(x) mod N. If H is a cryptographic hash function, such as H(x)=SHA256(x), with an unrestricted domain, then f(x) behaves exactly the same as in the above example, where the domain of f(x) is given by {0, 1, . . . , 2²⁵⁶−1} as this is the output range of H.

In this case, the corresponding probabilities P_{α}, P_{β} for the output ranges {0, 1, . . . , (2²⁵⁶−1)mod N} and {(2²⁵⁶−1 mod N)+1, (2²⁵⁶−1 mod N)+2, . . . , N−1} respectively are given by:

$${P}_{α} = \frac{⌊ \frac{{2}^{256}}{N} ⌋ + 1}{{2}^{256}} ,$$

$${P}_{β} = \frac{⌊ \frac{{2}^{256}}{N} ⌋}{{2}^{256}} ,$$

which also means that the maximum difference in probability is ½²⁵⁶.

This analysis has shown that there is a difference in probability of yielding different outputs of the composite hash function. It should be noted here that the absolute value of the difference is very small in the case of the composite hash function specified in WP0563, and that difference can be simply mitigated by either ensuring that N is a power of 2, or that N is a factor of k.

However, this may not be possible in all scenarios (e.g. where N is defined as a number of game elements, which is fixed by the game), in other cases the difference in probability may be much more significant if the composite hash functions does not include a cryptographic hash function. Furthermore, and if there is a non-zero difference (i.e. the output space of f(x) is not uniformly distributed) then the psychological impact of players/participants knowing that this exists may impact the likelihood of them being willing to participate.

In short, the fact that f(x) is not universally uniformly distributed means that the composite hash function that defines R_{N} may cause the problem mentioned above to arise for a particular scenario. In turn, this may make it is impossible to bring a set of players together to collaborate in generating R_{N}, in which case the PRNG mechanism has broken down.

According to embodiments of the present invention, an extension to the PRNG algorithm is introduced that mitigates the existence of any such preferential ordering of game elements (or data elements in general) on account of the initial ordering of the list of elements known to the players.

For each of the N players participating in a game, we introduce a player's choice 2 which we refer to as a ‘player nudge’ (i.e. the shift input). This is in addition to the individual player seed inputs that are used as inputs to the PRNG mechanism. The set of player nudges can then be used to modify the order of the list of game elements, based on the initial order of game elements, in a deterministic and unpredictable manner. This may involve transforming the position of an individual element (e.g. Pᵢ in a lottery) using the corresponding player nudge λᵢ, or by combining all the player nudges to produce a ‘game nudge’ denoted that can transform the full list of game elements.

A nudge may be generated in one of the following ways:
1. Each player provides a second random number 2 to the oracle as
   a. λ₀, λ₁, . . . , λ_{N}ϵ [symbol] *, or
   b. λ₀, λ₁, . . . , λ_{N}ϵ[0,n−1] for n symbols in the game (for example, n=6 for a dice, n=37 for roulette and n=52 for a deck of cards).
2. A trusted third party (TTP) e.g., the oracle, submits a game nudge λ.

We can use each player nudges independently or collectively, to produce a new order for the set of game elements based on the original ordering and the player nudges, by either:
1. Shifting the position of each game element (e.g. public key) in the initial ordered list by the corresponding player's chosen nudge, such that

$$\begin{matrix}{P}_{1} shifts by {λ}_{1} \\ {P}_{2} shifts by {λ}_{2} \\ ⋮ \\ {P}_{N} shifts by {λ}_{N}\end{matrix}$$

2. Shifting the position of the entire initial ordered list of game elements by the composite player nudge λ.

The random number R_{N} is then used to select an element from the re-ordered list.

Players may commit their individual choices in one of the following ways:
1. Include the hash digest of the player nudge in the initiation transaction, such that

$$\begin{matrix}Player 1 commits : H ( {X}_{1} ) , H ( {λ}_{1} ) \\ Player 2 commits : H ( {X}_{2} ) , H ( {λ}_{2} ) \\ ⋮ \\ Player N commits : N H ( {X}_{N} ) , H ( {λ}_{N} )\end{matrix}$$

where Xᵢ denoted the seed inputs.
2. Include the concatenation of the player nudge and the input seed as a hash digest, such that

$$\begin{matrix}Player 1 commits : H ( {X}_{1} ) , H ( {X}_{1} ‖ {λ}_{1} ) \\ Player 2 commits : H ( {X}_{2} ) , H ( {X}_{2} ‖ {λ}_{2} ) \\ ⋮ \\ Player N commits : H ( {X}_{N} ) , H ( {X}_{N} ‖ {λ}_{N} )\end{matrix}$$

where Xᵢ may be the leftmost 32-bytes and 2 may be the remaining bytes (e.g. 4 bytes) of the hash pre-image. Note that these are illustrative examples only.
3. Include only the concatenation of the player nudge and the input seed as a hash digest, such that

$$\begin{matrix}Player 1 commits : H ( {X}_{1} ‖ {λ}_{1} ) \\ Player 2 commits : H ( {X}_{2} ‖ {λ}_{2} ) \\ ⋮ \\ Player N commits : H ( {X}_{N} ‖ {λ}_{N} )\end{matrix}$$

Note that this option assumes that the size of at least Xᵢ (and optionally λᵢ) are predetermined.

For the case where the oracle generates and submits the nudge (i.e. the overall shift), then only they need to commit to this chosen value at the start of the game using either of the two methods above.

The fact that λ is unpredictable by any participant ensures that the inclusion of a nudge does mitigate any preferential ordering. The value of λ can be treated as a secure source of unpredictable randomness in the same sense that the value of ΣᵢXᵢ is considered unpredictably pseudo-random.

Recall the script used in the example PRNG method above to generate the random number R_{N} is given by

<R_{N}>, <s′₁><s′₂> . . . <s′_{N}>OP_ADD . . . OP_ADD OP_HASH256<N>OP_MOD
and the script used to select a winning element P_{w} from the ordered set of game elements (i.e. public keys) in the example of an N-player lottery is given by
<P_{W}>=<P₁><P₂> . . . <P_{N}><R_{N}>OP_ROLL OP_TOALTSTACK OP_DROP . . . OP_DROP OP_FROMALTSTACK.

We now introduce a new portion of script denoted by [λ] which can be added to <P_{W}> in order to alter the ordering of the public keys P₁, . . . P_{N} in the script using the player shifts/nudges. The script [λ] may take different forms depending on how the player nudges λ₁, . . . , λ_{N} are used in altering the set of keys. The locking script of the oracle transaction may take the following form:

<P_{W}>=<P₁><P₂> . . . <P_{N}>[λ]<R_{N}>OP_ROLL OP_TOALTSTACK OP_DROP . . . OP_DROP OP_FROMALTSTACK

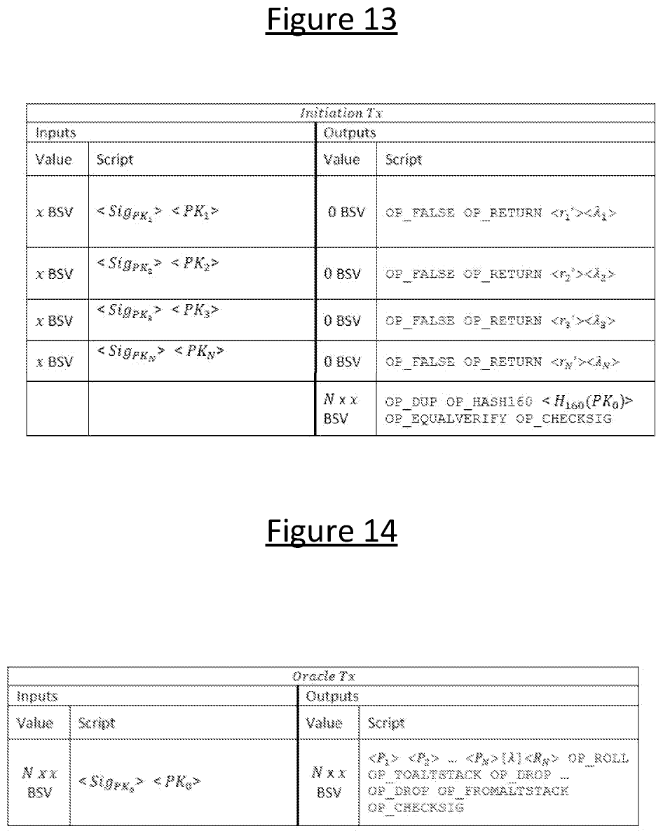

FIG. 13 illustrates a modified initiation transaction where each player includes their respective seed input r′₁ and their respective nudge input λ₁.

FIG. 14 illustrates a modified oracle transaction configured to re-order the list of elements.

The following provides an example script where one composite nudge λ is used to transform the list using a single number:

### [λ]=<λ>OP_DUP OP_TOALTSTACK <1>OP_ADD OP_ROLL OP_ROT OP_FROMALTSTACK OP_DUP OP_TOALTSTACK <2>OP_ADD OP_ROLL OP_ROT OP_FROMALTSTACK . . . OP_DUP OP_TOALTSTACK <N>OP_ADD OP_ROLL OP_ROT OP_FROMALTSTACK

This script has the effect of rolling elements to the top of the stack, and rotating the top three items of the stack, a total of N times. In this example, the composite nudge may be pre-calculated based on the player nudges, or the oracle 401 may provide the composite nudge.

Note that the sub-script “OP_DUP OP_TOALTSTACK <1>OP_ADD OP_ROLL OP_ROT OP_FROMALTSTACK” is repeated N times, but increments the value that is added to the composite lambda, to make sure all positions will be rolled to the top at some point. The composite nudge λ defines the position in the list of elements where the rolling starts from, and each time, the value of λ is incremented to cycle through all of the N positions in the list. The altstack is used to store the value of λ in between uses.

The following provides another example script where each player's nudge is used to transform the list separately:

[λ]=<λ₁><λ₂> . . . <λ_{N}>OP_TOALTSTACK . . . OP_TOALTSTACK OP_FROMALTSTACK OP_ROLL OP_ROT . . . OP_FROMALTSTACK OP_ROLL OP_ROT

Note that the opcode “OP_TOALTSTACK” is repeated N times, as is the sub-script OP_FROMALTSTACK OP_ROLL OP_ROT”. This script uses the same mechanism for altering the list of elements as the previous example, except each individual nudge is used independently.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of pseudo-randomly selecting a data element using blockchain transactions, wherein the method is performed by a first party and comprises:
obtaining an ordered list of data elements and a plurality of seed inputs;
generating a first transaction; and
causing the first transaction to be made available to one or more blockchain nodes for inclusion in the blockchain, wherein the first transaction comprises a first output script, and wherein when executed alongside an input script of a second transaction, the first output script is configured to:
output a re-ordered list of the data elements;
output a pseudorandom number generated based on the plurality of seed inputs; and
output, as a selected data element, the data element positioned at a position in the re-ordered list of data elements corresponding to the pseudorandom number.

Causing the first transaction to be made available to the one or more blockchain nodes may comprise transmitting the first transaction directly to those nodes. Alternatively, the first party may transmit the first transaction to an intermediary responsible for forwarding the first transaction to those nodes.

In the context of the present invention, outputting data may comprise outputting data to (i.e. pushing data to) a stack, e.g. a main stack or an alternative stack. The data may be temporarily pushed to the stack and then removed or otherwise operated on.

Outputting the selected data element may comprise storing the selected data element in memory, e.g. for use off-chain.

Statement 2. The method of statement 1, wherein the first output script is configured to output the re-ordered list of the data elements by:
outputting the ordered list of data elements; and
performing one or more re-ordering operations, wherein each re-ordering operation comprises changing the order of two or more of the data elements in the list of data elements.

Statement 3. The method of statement 2, wherein the performing of the one or more re-ordering operations comprises performing a total number of re-ordering operations corresponding to a total number of data elements in the list of ordered data elements.

That is, the number of re-ordering operations (e.g. rotations) is dependent on the number of elements.

Statement 4. The method of statement 2 or statement 3, wherein the first output script comprises an overall shift, and wherein performing each respective operation comprises re-ordering the two or more data elements based on the overall shift input.

Statement 5. The method of statement 4, wherein the overall shift is generated by the first party.

Statement 6. The method of statement 4 or statement 5, wherein the overall shift is generated based on a plurality of shift inputs, wherein one or more of the plurality of shift inputs are obtained from a respective user.

For instance, the overall shift may be a sum of the plurality of shift inputs. Or, the overall shift may be a concatenation of the plurality of shift inputs. Alternative functions may be applied to the plurality of shift inputs to generate the overall shift.

The plurality of shift inputs may be placed in an ordered list before generating the overall shift, e.g. as a hash of the summation or concatenation of the ordered list of shift inputs.

Statement 7. The method of statement 2 or statement 3, wherein the first output script comprises an ordered list of shift inputs, and wherein performing each respective operation comprises re-ordering the two or more data elements based on a respective one of the ordered list of shift inputs.

Statement 8. The method of statement 7, wherein one or more of the ordered list of shift inputs are obtained from a respective user.

Statement 9. The method of any preceding statement, wherein one or more of the ordered list of data elements are obtained from a respective user.

Statement 10. The method of statement 8 and statement 9, wherein a respective data element and a respective shift input obtained from the same respective user are positioned at corresponding positions in the ordered list of data elements and the ordered list of shift inputs respectively.

Statement 11. The method of any preceding statement, wherein one or more of the plurality of seed inputs are obtained from a respective user.

Statement 12. The method of statement 8 and statement 11, wherein the plurality of seed inputs are arranged in an ordered list seed inputs, and wherein a respective data element and a respective seed input obtained from the same respective user are positioned at corresponding positions in the ordered list of seed inputs and the ordered list of shift inputs respectively.

Statement 13. The method of any preceding statement, wherein the first output script comprises the plurality of seed inputs, and wherein the first output script is configured to generate the pseudorandom number.

Statement 14. The method of any preceding statement, wherein the pseudorandom number is generated by applying a composite hash function to the plurality of seed inputs.

A composite hash function is a hash function composed of multiple hash functions.

Statement 15. The method of statement 14, wherein applying the composite hash function to the plurality of seed inputs comprises:
generating an overall seed based on the plurality of seed inputs;
applying a first hash function to the overall seed to generate a first hash digest; and
applying a second hash function to the overall seed to generate a second hash digest.

For instance, the overall seed may be a sum of the plurality of seed inputs. Or, the overall seed may be a concatenation of the plurality of seed inputs. Alternative functions may be applied to the plurality of seed inputs to generate the overall seed.

Statement 16. The method of statement 15, wherein the second hash function is a modulo function.

The first hash function may be a cryptographic hash function.

Statement 17. The method of statement 6 or statement 8, or any statement dependent thereon, wherein the first transaction comprises an input referencing an output of an initiation transaction, wherein the initiation transaction comprises a respective commitment from each respective user, and wherein the respective commitment commits to the shift input obtained from the respective user.

Statement 18. The method of statement 6 or statement 8, or any statement dependent thereon, wherein the first transaction comprises multiple inputs, each referencing an output of a respective initiation transaction, wherein each initiation transaction comprises a respective commitment from a respective user, and wherein the respective commitment commits to the shift input obtained from the respective user.

Statement 19. The method of statement 17 or statement 18, wherein each respective commitment is generated by applying a hash function to at least the respective shift input.

Statement 20. The method of statement 19, wherein each respective commitment is generated by applying a hash function to at least the respective shift input and the respective seed input from the same respective user.

Statement 21. The method of any preceding statement, comprising obtaining a second plurality of seed inputs, wherein one or more of the second plurality of seed inputs are obtained from a respective user, and wherein the pseudorandom number is generated based on the plurality of seed inputs and the second plurality of seed inputs.

Statement 22. The method of any preceding statement, wherein at least one of the data elements is generated by the first party.

Statement 23. The method of any preceding statement, wherein the data elements are public keys.

Statement 24. The method of statement 23, wherein the first output script is configured to lock the first output to the selected public key.

Statement 25. The method of any preceding statement, comprising supplying the selected data element to an off-chain function.

An off-chain function is a function that is not executed on the blockchain or in the context of the blockchain. For instance, the off-chain function may be a computer simulation or a cryptographic key generator.

Statement 26. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 25.
Statement 27. A computer program embodied on computer-readable storage and configured so as, when run on one or more processors, to perform the method of any of statements 1 to 25.

According to another aspect disclosed herein, there may be provided a method comprising the actions of the first party and the respective users.

According to another aspect disclosed herein, there may be provided a system comprising the computer equipment of the first party and the respective users.

1. A computer-implemented method of pseudo-randomly selecting a data element using blockchain transactions, wherein the method is performed by a first party and comprises:
obtaining an ordered list of data elements and a plurality of seed inputs;
generating a first transaction; and
causing the first transaction to be made available to one or more blockchain nodes for inclusion in the blockchain, wherein the first transaction comprises a first output script, and wherein when executed alongside an input script of a second transaction, the first output script is configured to:
output a re-ordered list of the data elements;
output a pseudorandom number generated based on the plurality of seed inputs; and
output, as a selected data element, the data element positioned at a position in the re-ordered list of data elements corresponding to the pseudorandom number.

2. The method of claim 1, wherein the first output script is configured to output the re-ordered list of the data elements by:
outputting the ordered list of data elements; and
performing one or more re-ordering operations, wherein each re-ordering operation comprises changing the order of two or more of the data elements in the list of data elements.

3. The method of claim 2, wherein the performing of the one or more re-ordering operations comprises performing a total number of re-ordering operations corresponding to a total number of data elements in the list of ordered data elements.

4. The method of claim 2, wherein the first output script comprises an overall shift, and wherein performing each respective operation comprises re-ordering the two or more data elements based on the overall shift.

5. (canceled)

6. The method of claim 4, wherein the overall shift is generated based on a plurality of shift inputs, wherein one or more of the plurality of shift inputs are obtained from a respective user.

7. The method of claim 2, wherein the first output script comprises an ordered list of shift inputs, and wherein performing each respective operation comprises re-ordering the two or more data elements based on a respective one of the ordered list of shift inputs.

8. The method of claim 7, wherein one or more of the ordered list of shift inputs are obtained from a respective user, wherein one or more of the ordered list of data elements are obtained from a respective user, and wherein a respective data element and a respective shift input obtained from the same respective user are positioned at corresponding positions in the ordered list of data elements and the ordered list of shift inputs respectively.

9-10. (canceled)

11. The method of claim 8, wherein one or more of the plurality of seed inputs are obtained from a respective user, and wherein the plurality of seed inputs are arranged in an ordered list seed inputs, and wherein a respective data element and a respective seed input obtained from the same respective user are positioned at corresponding positions in the ordered list of seed inputs and the ordered list of shift inputs respectively.

12. (canceled)

13. The method of claim 1, wherein the first output script comprises the plurality of seed inputs, and wherein the first output script is configured to generate the pseudorandom number.

14. The method of claim 1, wherein the pseudorandom number is generated by applying a composite hash function to the plurality of seed inputs.

15. The method of claim 14, wherein applying the composite hash function to the plurality of seed inputs comprises:
generating an overall seed based on the plurality of seed inputs;
applying a first hash function to the overall seed to generate a first hash digest; and
applying a second hash function to the overall seed to generate a second hash digest.

16. (canceled)

17. The method of claim 6, wherein the first transaction comprises an input referencing an output of an initiation transaction, wherein the initiation transaction comprises a respective commitment from each respective user, and wherein the respective commitment commits to the shift input obtained from the respective user.

18. The method of claim 6, wherein the first transaction comprises multiple inputs, each referencing an output of a respective initiation transaction, wherein each initiation transaction comprises a respective commitment from a respective user, and wherein the respective commitment commits to the shift input obtained from the respective user.

19. The method of claim 17, wherein each respective commitment is generated by applying a hash function to at least the respective shift input.

20. (canceled)

21. The method of claim 1, comprising obtaining a second plurality of seed inputs, wherein one or more of the second plurality of seed inputs are obtained from a respective user, and wherein the pseudorandom number is generated based on the plurality of seed inputs and the second plurality of seed inputs.

22. (canceled)

23. The method of claim 1, wherein the data elements are public keys.

24. The method of claim 23, wherein the first output script is configured to lock the first output to the selected public key.

25. The method of claim 1, comprising supplying the selected data element to an off-chain function.

26. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus to perform a method of pseudo-randomly selecting a data element using blockchain transactions, wherein the method is performed by a first party and comprises:
obtaining an ordered list of data elements and a plurality of seed inputs;
generating a first transaction; and
causing the first transaction to be made available to one or more blockchain nodes for inclusion in the blockchain, wherein the first transaction comprises a first output script, and wherein when executed alongside an input script of a second transaction, the first output script is configured to:
output a re-ordered list of the data elements;
output a pseudorandom number generated based on the plurality of seed inputs; and
output, as a selected data element, the data element positioned at a position in the re-ordered list of data elements corresponding to the pseudorandom number.

27. A computer program embodied on a non-transitory computer-readable storage and configured so as, when run on one or more processors, the one or more processors perform a method of pseudo-randomly selecting a data element using blockchain transactions, wherein the method is performed by a first party and comprises:
obtaining an ordered list of data elements and a plurality of seed inputs;
generating a first transaction; and
causing the first transaction to be made available to one or more blockchain nodes for inclusion in the blockchain, wherein the first transaction comprises a first output script, and wherein when executed alongside an input script of a second transaction, the first output script is configured to:
output a re-ordered list of the data elements;
output a pseudorandom number generated based on the plurality of seed inputs; and
output, as a selected data element, the data element positioned at a position in the re-ordered list of data elements corresponding to the pseudorandom number.
